(19) United States
(12) Patent Application Publication
(10) Pub. No.: US 2012/0286506 A1
(43) Pub. Date: Nov. 15, 2012

(54) WATER MANIFOLD

(76) Inventor: Daniel McKenzie, Georgetown (CA)

(21) Appl. No.: 13/460,948

(22) Filed: May 1, 2012

Related U.S. Application Data
(60) Provisional application No. 61/484,425, filed on May 10, 2011.

(51) Int. Cl. F16L 41/02

(52) U.S. Cl. 285/119; 285/125.1

(57) ABSTRACT

A manifold housing which includes an inlet end for receiving fluid in communication with a main channel defined within the housing. The housing includes a series of outlets in fluid communication with the main channel. The outlets are for connecting outlet pipes thereto, wherein the inlet end having inlet threads for receiving standard pipe threaded fittings therein. Preferably the outlets of the manifold housing includes upwardly projecting lugs attached at one end to a bottom of the outlet, wherein the lugs for abutting with a lug end of a crimp ring used to secure an outlet pipe to the outlet.

This application claims priority from previously filed U.S. Provisional Patent Application No. 61/484,425 filed May 10, 2011 titled: WATER MANIFOLD in the name of Daniel McKenzie.

### FIELD OF THE INVENTION

The present invention relates to water manifolds and in particular relates to pressurized water manifolds manufactured from poly phenyl sulphone.

### BACKGROUND OF THE INVENTION

There is a shift in materials used for distributing potable water in buildings across North America. Currently most plumbing and potable water fittings are made from copper and/or brass. Due to California and other state legislation there is a shift from copper and brass fittings to the use of poly phenyl sulphone fittings. In addition traditional copper piping is moving towards PEX flexible tubing for applications in the distribution of potable water in residential and commercial buildings. PEX stands for cross linked poly ethylene and is a very durable tubing especially under hot and cold water extremes. PEX is used to replace copper tubing and allows for a significant savings both in cost as it relates copper and it's ease in installation, which converts to time saved.

There is a need for fittings and specifically manifolds, which can be used in conjunction with the PEX tubing. To date the only suitable material, which has been identified is poly phenyl sulphone and there is little experience and/or technology in the market place currently in regard to the manufacture of fittings from poly phenyl sulphone.

### BRIEF DESCRIPTION OF THE DRAWINGS

The present concept will now be described by way of example only with reference to the following drawings in which;

FIG. 1 is a side elevational view of a four outlet manifold.

FIG. 2 is an end plan view of the manifold shown in FIG. 1.

FIG. 3 is a schematic cross sectional view of the manifold shown in FIG. 1.

FIG. 4 is a schematic cross sectional view of the manifold shown in FIG. 1 together with an outlet pipe deployed thereon showing the use of a crimp ring.

FIG. 5 is a side perspective view of the manifold shown in FIG. 1.

FIG. 6 is a top side perspective view of the manifold shown in FIG. 1.

FIG. 7 is a side elevational view of a manifold clip.

FIG. 8 is a top side perspective view of the manifold clip shown in FIG. 1.

FIG. 9 is a top perspective view of the manifold shown in FIG. 1 together with two manifold clips, which are shown in FIG. 7 wherein the manifold is deployed with the manifold clips.

FIG. 10 is an alternate embodiment of the present invention a six outlet manifold with a closed end.

FIG. 11 is a end plan view of the manifold shown in FIG. 12.

FIG. 12 is a side cross sectional view of the six outlet manifold shown in FIG. 10.

FIG. 13 is a side perspective view of an alternate embodiment of the manifold shown in FIG. 1 deployed with manifold clips and inlet and exit fittings.

FIG. 14 is a schematic cross sectional view of the manifold shown in FIG. 13.

### DETAILED DESCRIPTION OF THE PREFERRED EMBODIMENTS

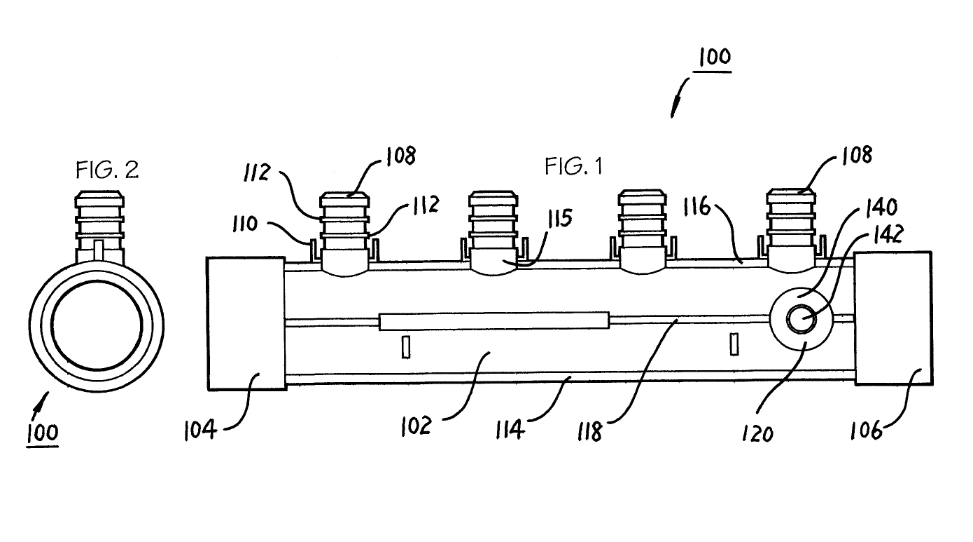

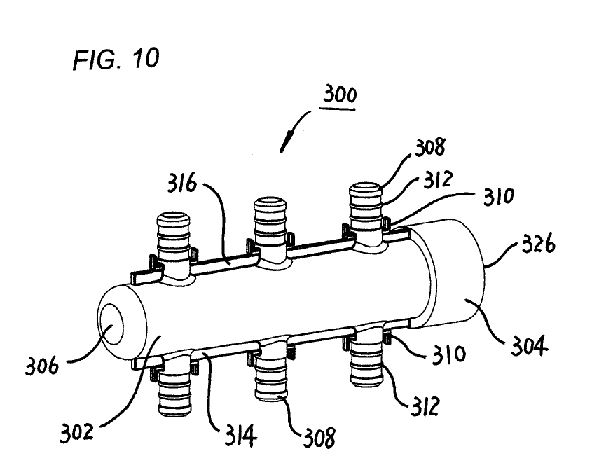

The present concept is shown generally as manifold 100 in FIG. 1 and manifold 300 in FIG. 10.

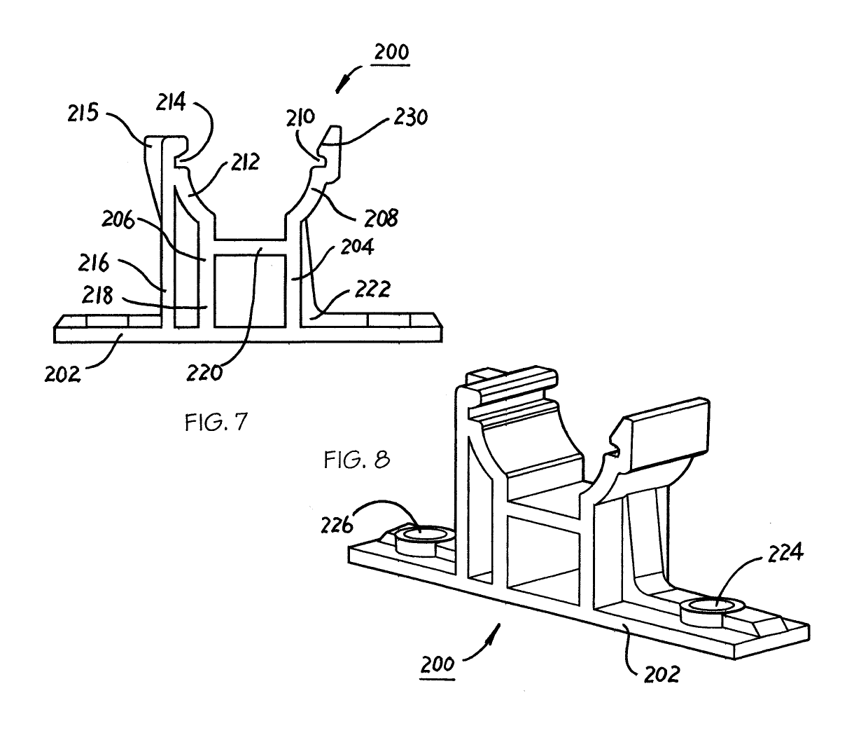

There further is an accessory to both manifold 100 shown in FIG. 1 and manifold 300 shown in FIG. 10 namely a manifold clip shown generally as 200 in FIGS. 7 and 8.

Referring first of all to FIG. 1 manifold shown generally as 100 includes the following major components namely housing 102, having a main wall 127 inlet end 104, exit end 106, four outlets 108 having lugs 110 and bands 112. Lugs 110 emanate from a bottom 115 of outlet 108 and project upwardly. There may be one or more lugs surrounding each outlet 108 but preferably there are two as depicted.

The housing 102 further including at least one set of two horizontally opposed longitudinally extending radially projecting ribs 114, 116 and 118 for attaching accessories thereto. Manifold 100 preferably includes a bottom rib 114, a top rib 116, and two side ribs 118. It also preferably includes a tapping port 120 which includes a tapping lug 140 and a tapping hole 142. The tapping ports 120 for adding additional fittings to the manifold.

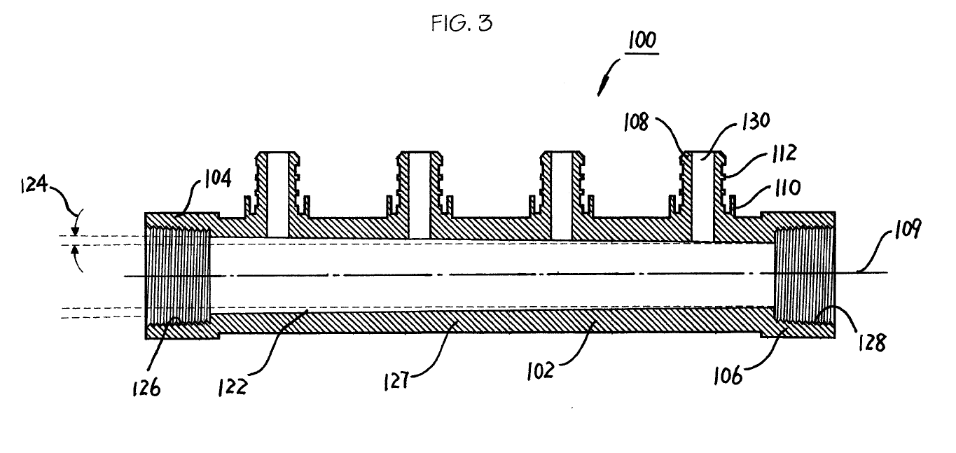

Referring now to FIG. 3 which is a schematic diagram of manifold 100 shown in cross sectional view. Manifold 100 oriented along a longitudinal axis 109 includes inlet threads 126 and exit threads 128 which are standard pipe threads adapted to receive male threaded pipe fittings. Manifold 100 has a longitudinally oriented main channel 122 which is slightly larger at inlet end 104 than at exit end 106 which is shown as taper 124. In practice it is found that the angle subtended by taper 124 is between 3 and 8 degrees. Preferably the angle is 5 degrees over the length of main channel 122.

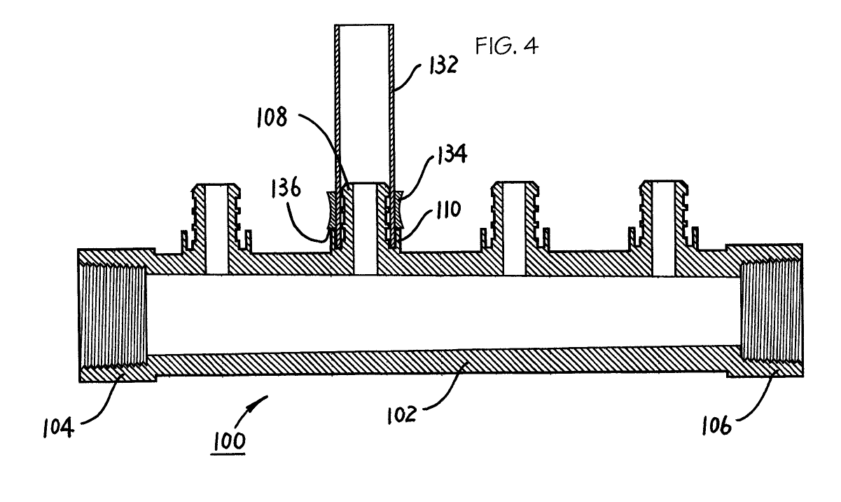

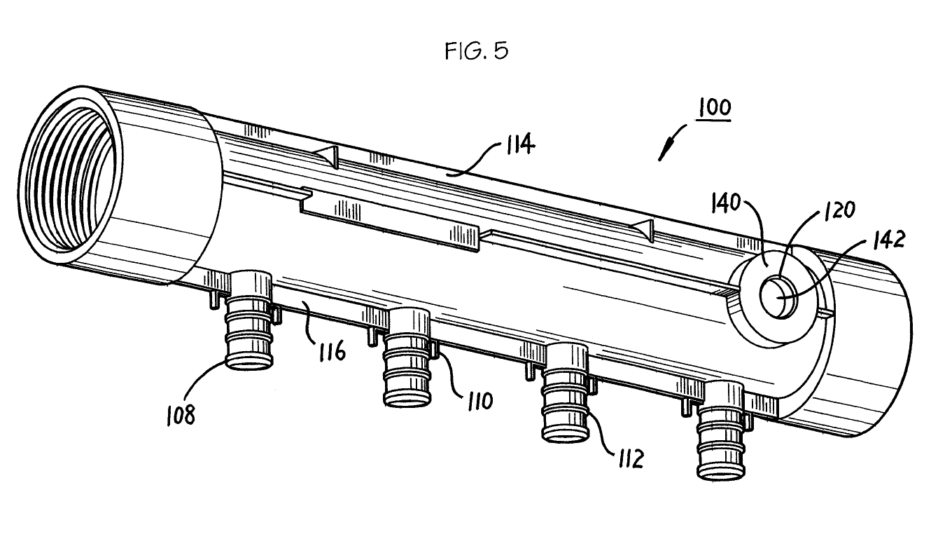

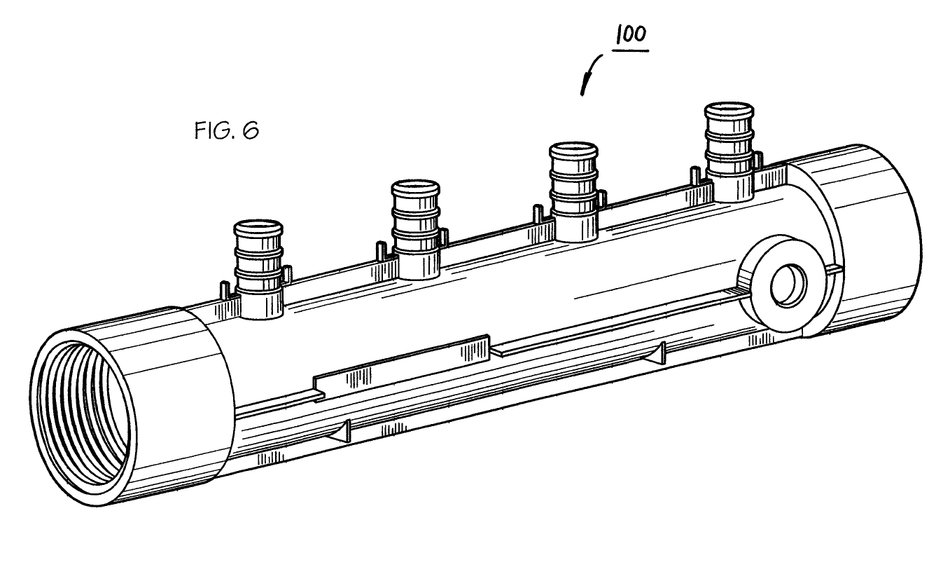

Referring now to FIG. 4 manifold 100 is shown together with an outlet pipe 132 deployed on one of the outlets 108.

The reader will note that each outlet 108 includes a lug 110 which acts as a stop for the lug end 136 of crimp ring 134. The reader will also note that each outlet 108 includes two bands 112 which aid in the sealing of outlet pipe 132 around outlet 108 by using crimp ring 134. Outlet 108 directs fluid out of an orifice 130.

Housing 102 is generally cylindrical in shape and includes an inlet end 104 which includes a standard pipe threaded inlet thread 126 and standard pipe threaded exit threads 128. Commercially available standard pipe fittings having standard pipe threads can be threaded into either inlet end 104 or exit end 106. Therefore manifold 100 can be adapted to fit almost any incoming sized piping that is presently available for industrial and commercial potable water installations in buildings.

Referring now to FIGS. 7 and 8 which depicts a manifold clip shown generally as 200 which includes a base 202, right arm 204 which includes a lower rib 222u, a left arm 206, a right finger 208 which includes a right indent 210 and chamfered portion 230. Manifold clip 200 further includes a left finger 212 having a left indent 214 and an upper rib 215. Left arm 206 includes a first upright 216 and a second upright 218 which are connected near the top by left finger 212 and is interconnected with right arm 204 with cross member 220.

As best shown in FIG. 8 manifold clip 200 further includes a right aperture 224 and a left aperture 226 for fastening the base 202 to any suitable sub-strait.

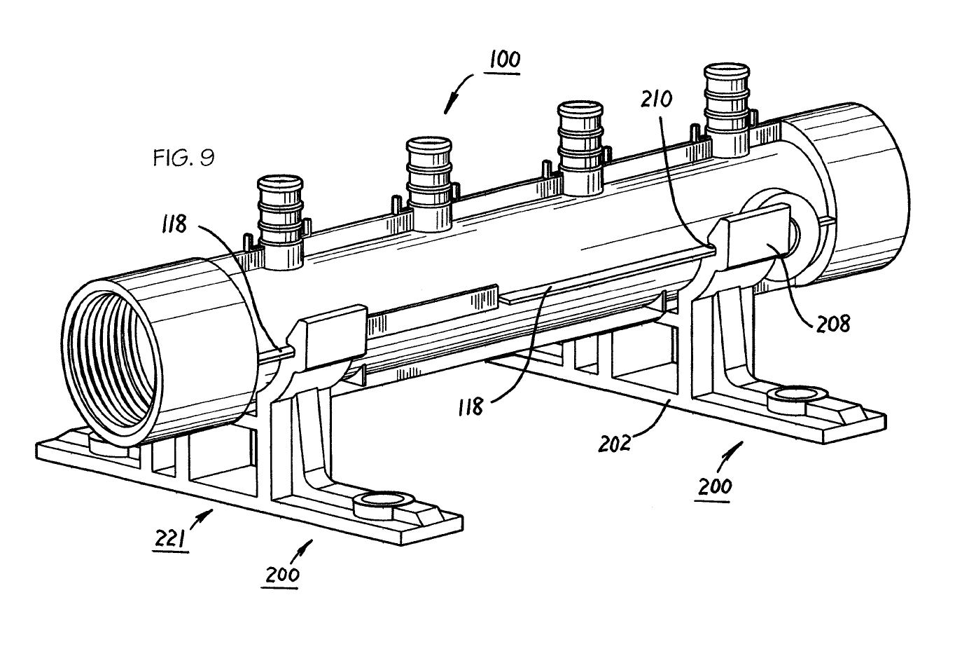

FIG. 9 shows two manifold clips 200 deployed together with manifold 100. The reader will note that the side ribs 118 of manifold 100 engage with right indent 210 and left indent 214 of manifold clip 200 thereby placing manifold 100 in the clipped position 221. The right indent 210 and left indent 214 of manifold clip 200 may also engage with the top rib 116 and bottom rib 114 in similar fashion as with the side ribs 118.

In order to put manifold 100 into clip position 221 firstly a side rib 118 is placed into left indent 214 and then the other side rib 118 is slideably urged along chamfered portion 230 of right finger 208 until the side rib 118 engages with right indent 210.

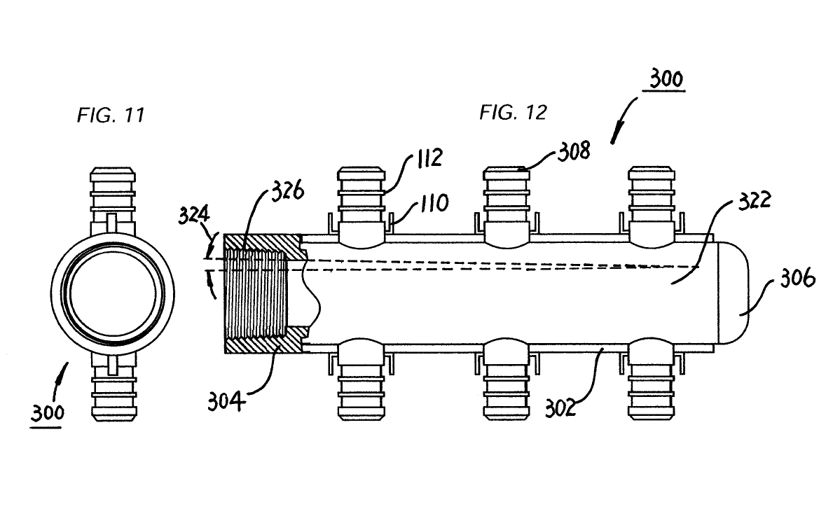

Referring now to FIGS. 10, 11 and 12 which shows manifold 300 which includes the following major components namely housing 302 and inlet end 304, a closed end 306, six outlets 308 each having lugs 310 and bands 312.

Housing 302 further includes a bottom rib 314 and a top rib 316. Referring now to FIG. 12 which shows manifold 300 in schematic cross sectional view and includes a housing 302 having a main channel 322 which is larger at inlet end 304 and slightly smaller at closed end 306. The main channel 322 therefore is tapered which is depicted as taper 324 in FIG. 12. This taper preferably is anywhere from 3 to 8 degrees and preferably is 5 degrees.

Manifold 300 further includes inlet threads 326 for receiving any standard pipe fittings therein.

Bottom ribs 314 and top ribs 316 are designed to engage with right indent 210 and left indent 214 of manifold clip 200 therefore although not shown manifold clips 200 can be used either with manifold 100 and/or with manifold 300.

In most respects manifold 300 is very similar if not the same as manifold 100 with the exception that manifold 100 includes both a threaded inlet end 104 and a threaded exit end 106 wherein manifold 300 only includes a threaded inlet end 304 and a closed end 306.

Manifold 100 could also be fitted with outlets 108 projecting from the top and bottom of housing 102. Likewise manifold 300 could be fitted with only outlets 308 projecting from the top of housing 302 rather than the top and bottom as shown in the Figures.

The reader will note that the manifolds 100 could be made larger or smaller with fewer or more outlets 108 which are normally evenly spaced along the housing 102 in the case of manifold 100 or the housing 302 in the case of manifold 300. In addition outlets can be fitted to extend out of the top portion of housing 102 as shown in the examples of manifold 100 or outlets could be shown to extend out of the top and bottom portions of housing 302 as shown for manifold 300.

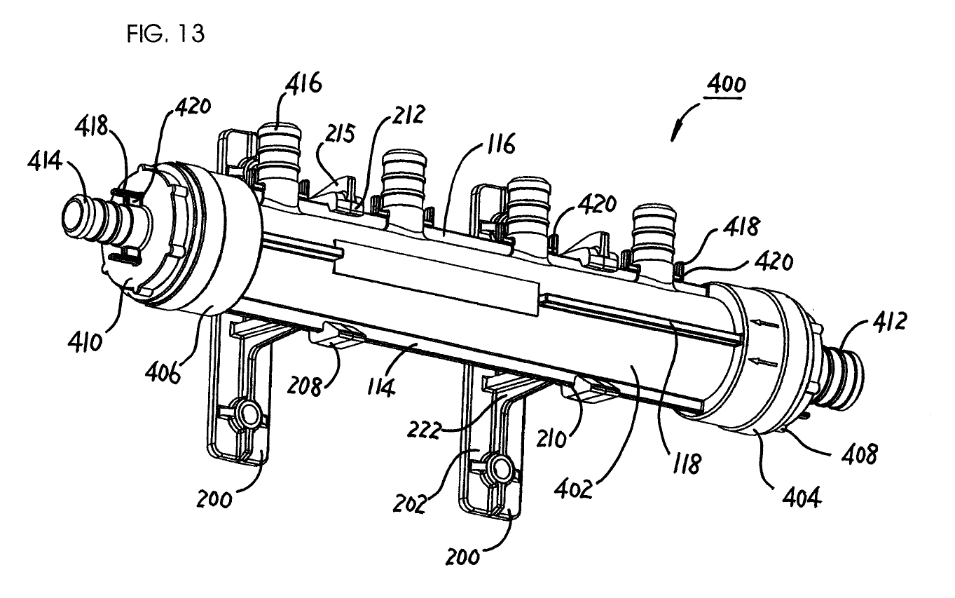

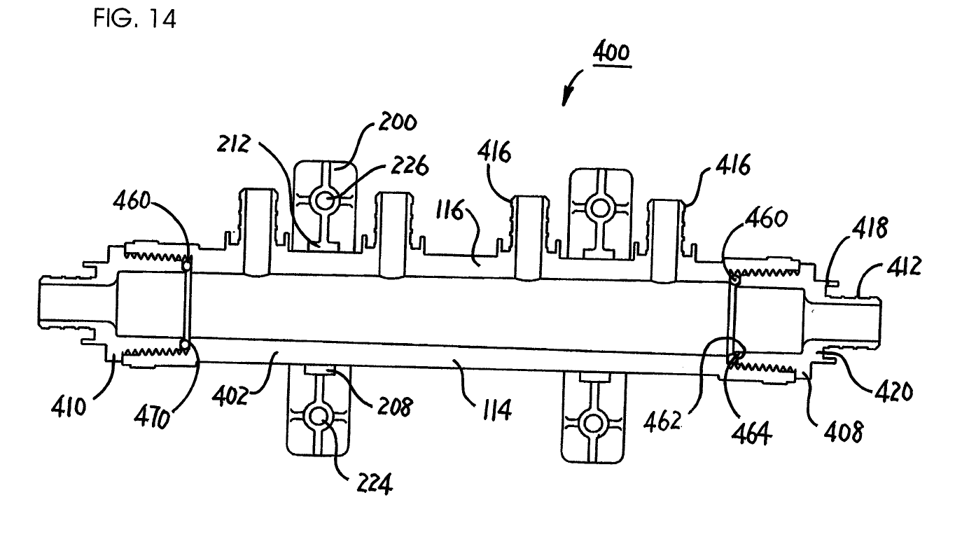

Referring now to FIGS. 13 and 14 a manifold 400 is shown deployed with manifolds clips 200 and an inlet fitting 408 and an exit fitting 410.

Manifold 400 includes housing 402 having an inlet end 404, and an exit end 406 wherein an inlet fitting 408 is threadably screwed into the inlet end 404 and an exit fitting 410 as threadably screwed into an exit end 406. Manifold 400 further includes numerous outlets 416, each having a lug 418 and a stop 420.

Inlet fitting 408 includes a central inlet 412 and exit fitting 410 includes a central outlet 414.

Manifold 400 further includes a top rib 116, side ribs 118 on each side of the housing 402 and a bottom rib 114. The ribs are arranged symmetrically around housing 402 preferably separated by 90 degree arcs between each of the ribs. In other words there are a total of four ribs, a top rib 116, separated by 90 degrees to a side rib 118, separated by 90 degrees to a bottom rib 114 which is separated by 90 degrees to another side rib 118. Preferably manifold 400 includes a total of 4 ribs namely 2 side ribs 118, a top rib 116 and a bottom rib 114.

Manifold 400 is shown deployed onto manifold clips 200 which include a base 202, right finger 208, a right indent 210, a left finger 212 and an upper rib 215.

Referring now to FIG. 14 which shows manifold 400 schematically in cross sectional view the reader will note that the inlet fitting 408 includes a shoulder 462 and a lip 464 for receiving o-ring 460 thereon. O-ring 460 makes contact with sealing surface 470 which is part of the housing 402 of manifold 400.

Lug 418 serves to position crimp ring 134 by butting up lug end 136 against lug 418.

Stop 420 serves to position outlet pipe 132 onto outlet 416 by ensuring that the end of outlet pipe 132 buts up against stop 420. The positioning of outlet pipe 132 as shown in FIG. 4 would be similar on the outlets 416 of manifold 400 with the addition that the stops 420 would position the end of the outlet pipe in similar fashion as the lugs 418 position the lug end 136 of crimp ring 134. The outlets 416, 412, and 414include upwardly projecting lugs 418 and stops 420 attached at one end proximate to a bottom of the outlet. The lug 418 abutts with a lug end of a crimp ring 134, and the stop abutts with the end of the outlet pipe 132, such that the crimp ring 134 and outlet pipe 132 are properly aligned over the outlet.

The reader will note that manifold clip 200 can be clipped into position as shown in FIG. 13 wherein the clips attach to the top rib 116 and the bottom rib 114.

The manifold clips 200 can also clip onto the manifold 400 as shown in FIG. 9 for manifold 100 wherein the manifold clip attaches to the side ribs 118 of the manifold.

In this manner manifold clip 200 can be mounted either onto a horizontal surface as in FIG. 9 or onto a vertical surface as in FIG. 13. The same applies for manifold 100. The manifold clip 200 includes a right arm 204 connected at one end to the base 202 and at the other end to the right finger 208, and a left arm 206 connected at one end to the base 202 and at the other end to the left finger 212 such that the fingers resiliently bias against the ribs of the housing 402 or 102 in the clipped position 221.

Manifold 400 is very similar to manifold 100 with the further addition of the o-ring 460 and the shoulder 462 and lip 464 which are included in the inlet fitting 408 and the exit fitting 410 to ensure that there is a water tight seal between the manifold 400 and the fittings 408 and 410.

It should be apparent to persons skilled in the arts that various modifications and adaptation of this structure described above are possible without departure from the spirit of the invention the scope of which defined in the appended claim.

I claim:

1. A manifold comprising:
a) a housing which includes an inlet end for receiving fluid in communication with a main channel defined within the housing;
b) a series of outlets in fluid communication with the main channel, the outlets for connecting outlet pipes thereto;
c) the inlet end having inlet threads for receiving an inlet fitting therein;
d) the housing further including at least one set of two horizontally opposed longitudinally extending radially projecting ribs for attaching accessories thereto.

2. The manifold housing claimed in claim 1 wherein the outlets include upwardly projecting lugs and stops attached at one end proximate to a bottom of the outlet, the lug for abutting with a lug end of a crimp ring, and the stop for abutting with the end of the outlet pipe, such that the crimp ring and outlet pipe are properly aligned over the outlet.

3. The manifold housing claimed in claim 1 wherein the housing further including at least two sets of two horizontally opposed longitudinally extending radially projecting ribs, the first set including a top rib and a bottom rib and the second set including side ribs.

4. The manifold housing claimed in claim 1 wherein the housing further includes an exit end having exit threads for threadably receiving pipe fittings therein.

5. The manifold housing claimed in claim 1 wherein the inlet fitting including a shoulder and lip for receiving an o-ring thereon for sealing against a sealing surface of the housing.

6. The manifold housing claimed in claim 1 wherein the housing further includes a tapping port which includes a tapping lug and a taping hole.

7. In combination a manifold and a manifold clip, the combination comprising:
a) the manifold including a housing which includes an inlet end for receiving fluid in communication with a main channel defined within the housing;
b) a series of outlets in fluid communication with the main channel, the outlets for connecting outlet pipes thereto;
c) the inlet end having inlet threads for receiving an inlet fitting therein;
d) the housing further including at least one set of two horizontally opposed longitudinally extending radially projecting ribs for attaching accessories thereto; and
e) at least one manifold clip adapted to detachably clip onto the least one set of ribs.

8. The combination claimed in claim 7 wherein the manifold clip includes a left and right finger projecting from a base, wherein the fingers adapted to detachably clip onto the set of ribs.

9. The combination claimed in claim 8 wherein the manifold clip further includes a right arm connected at one end to the base and at the other end to the right finger, and a left arm connected at one end to the base and at the other end to the left finger such that the fingers resiliently bias against the ribs in a clipped position.

10. The combination claimed in claim 8 wherein the left and right fingers each include an indent for co-operatively engaging onto the at least one set of ribs in a clipped position.

11. The combination claimed in claim 7 wherein wherein the outlets include upwardly projecting lugs and stops attached at one end proximate to a bottom of the outlet, the lug for abutting with a lug end of a crimp ring, and the stop for abutting with the end of the outlet pipe, such that the crimp ring and outlet pipe are properly aligned over the outlet.

12. The combination claimed in claim 7 wherein wherein the housing further including at least two sets of two horizontally opposed longitudinally extending radially projecting ribs, the first set including a top rib and a bottom rib and the second set including side ribs.

13. The combination claimed in claim 7 wherein the housing further includes an exit end having exit threads for threadably receiving pipe fittings therein.

14. The combination claimed in claim 7 wherein the inlet fitting including a shoulder and lip for receiving an o-ring thereon for sealing against a sealing surface of the housing.

15. The combination claimed in claim 7 wherein the housing further includes a tapping port which includes a tapping lug and a taping hole.
